(19) United States
(12) Patent Application Publication
(10) Pub. No.: US 2007/0274163 A1
(43) Pub. Date: Nov. 29, 2007

(54) Clockwork Item With Reversible Watch Container

(76) Inventor: Daniel Wild, Le Sentier (CH)

Correspondence Address: YOUNG & THOMPSON, 745 SOUTH 23RD STREET, 2ND FLOOR, ARLINGTON, VA, 22202, US

(21) Appl. No.: 10/578,076

(22) PCT Filed: Oct. 21, 2004
(86) PCT No.: PCT/IB04/03497

§ 371 Date: Mar. 19, 2007

(30) Foreign Application Priority Data
Nov. 4, 2003 (CH) 01883/03

(51) Int. Cl. G04B 37/14

(52) U.S. Cl. 368/316

(57) ABSTRACT

The timepiece comprises a frame (3) in which a watch case (7, 8, 9) is reversibly mounted. The watch case (7, 8, 9) is rotatable within the frame (3) around a determined axis (22) traversing the flank (24) of the watch case (7, 8, 9) and the inner flank (25) of the frame (3). The flank (24) of the watch case (7, 8, 9) and the inner flank (25) of the frame (3) substantially are parts of a same surface of rotation around the determined axis (22) so as to reduce the gap between the frame (3) and the watch case (7, 8, 9).

The present invention relates to a timepiece with reversible watch case, and more particularly to a timepiece having a frame and a watch case reversibly mounted in the frame in order to be able to adopt a first position in which the dial of the watch case is visible and a second position or turned position in which the back cover or another dial of the watch case is visible.

Such timepieces have been described in the documents CH 181 003, CH 189 911 and FR 733 729. They all have the drawback of leaving a gap between the frame and the watch case when the latter is in either of the two positions mentioned above, which detracts from the aesthetic appearance of the timepiece.

The present invention aims at remedying this drawback, or at least at attenuating it, and provides to this end a timepiece, in particular a wristwatch, according to appended claim 1, particular embodiments being defined in the dependent claims.

Other features and advantages of the present invention will become apparent upon reading the following detailed description given with reference to the appended drawings in which:

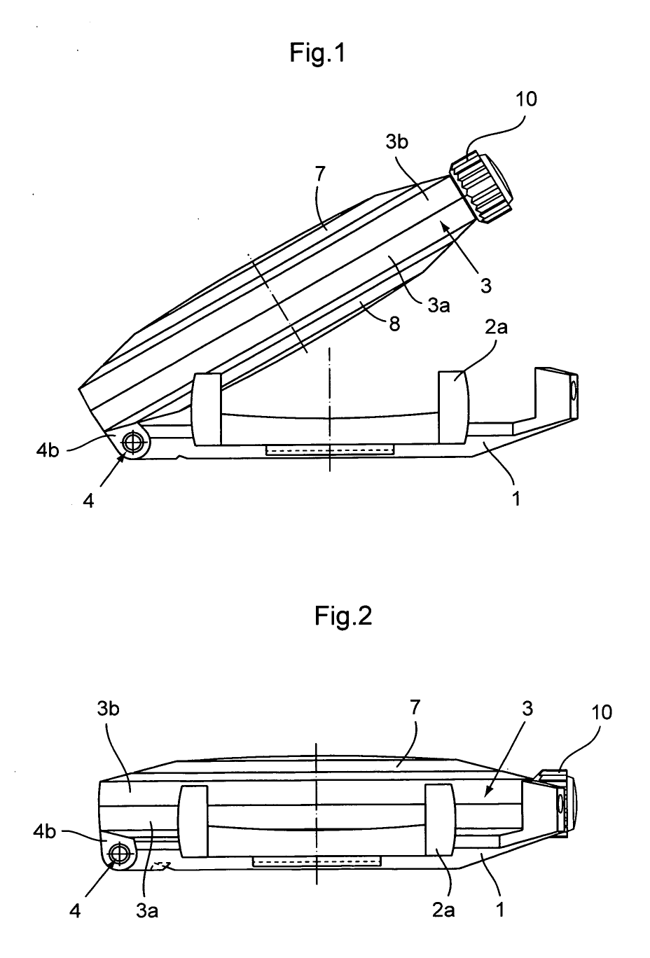

FIGS. 1 and 2 are profile views representing a watch according to a first embodiment of the invention, in an intermediate open position and in a closed position, respectively;

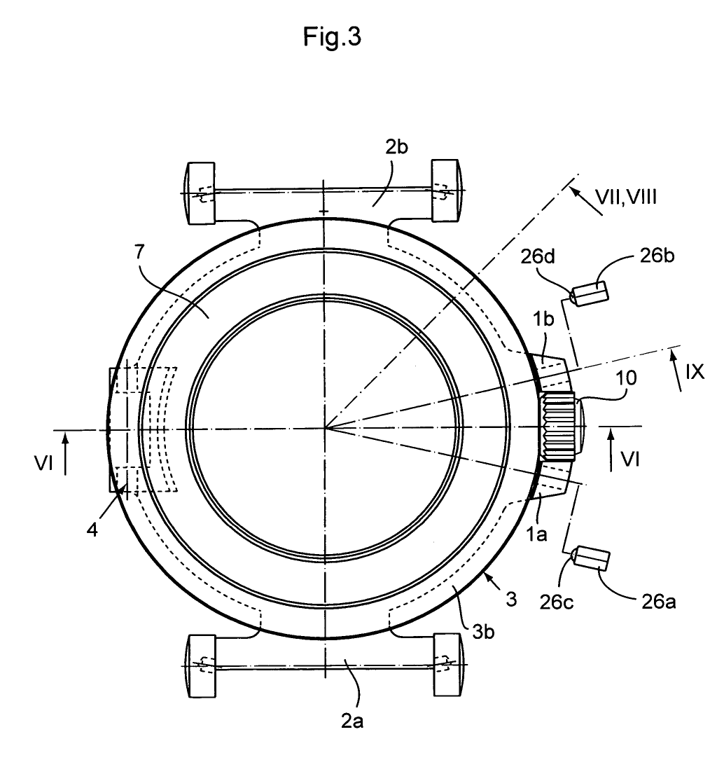

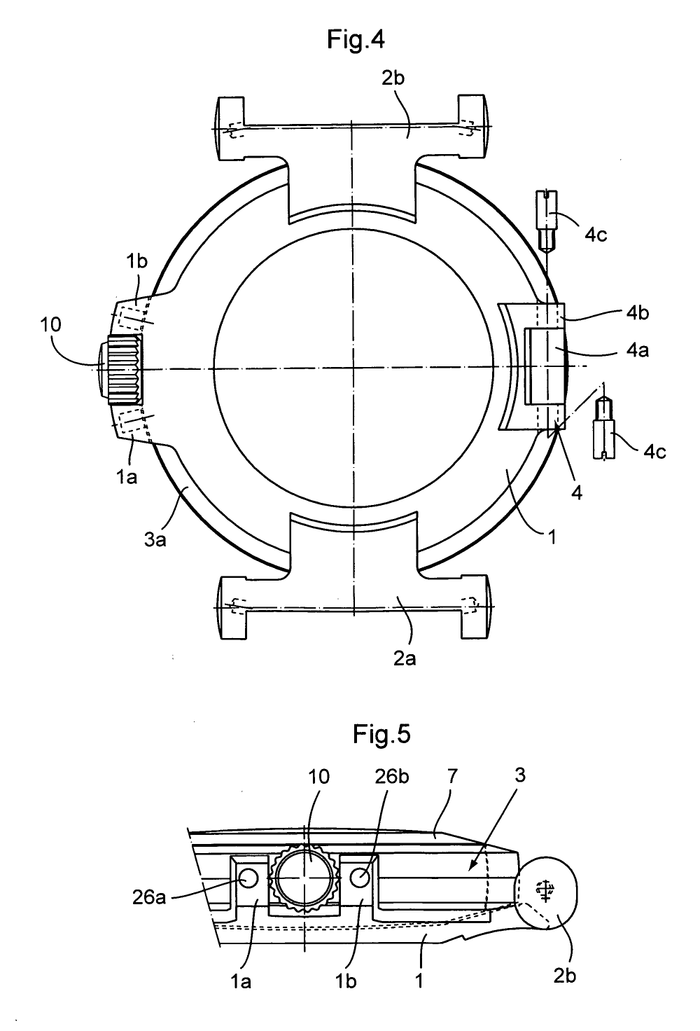

FIGS. 3 and 4 are top and bottom views of the watch according to the first embodiment of the invention;

FIG. 5 is a partial profile view of the watch according to the first embodiment of the invention that shows particularly a setting crown and crown-protecting projections of this watch;

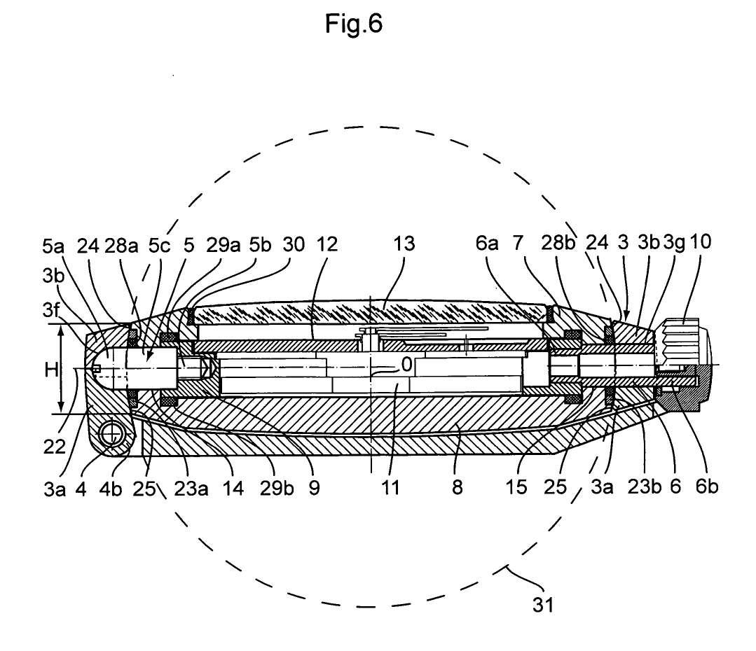

FIG. 6 is a cross-sectional view of the watch according to the first embodiment of the invention taken along the line VI-VI of FIG. 3;

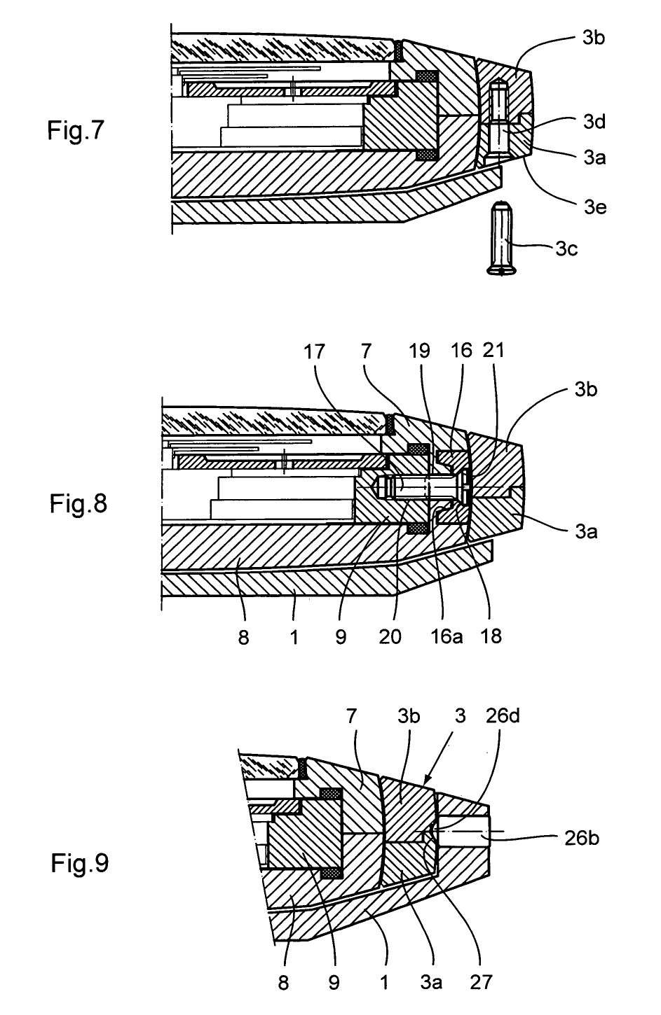

FIG. 7 is a partial cross-sectional view of the watch according to the first embodiment of the invention taken along the line VII, VIII of FIG. 3, and representing particularly in an exploded position a tapped hole and a matching screw serving to assemble two parts of a frame of the watch; for reasons of clarity, a bell and a mounting screw serving to assemble two parts of the watch case have not been represented in FIG. 7;

FIG. 8 is a partial cross-sectional view of the watch according to the first embodiment of the invention taken along the line VII, VIII of FIG. 3, and representing particularly the bell and the mounting screw mentioned earlier; for reasons of clarity, the tapped hole and matching screw illustrated in FIG. 7 have not been represented in FIG. 8;

FIG. 9 is a partial cross-sectional view of the watch according to the first embodiment of the invention taken along line IX of FIG. 3;

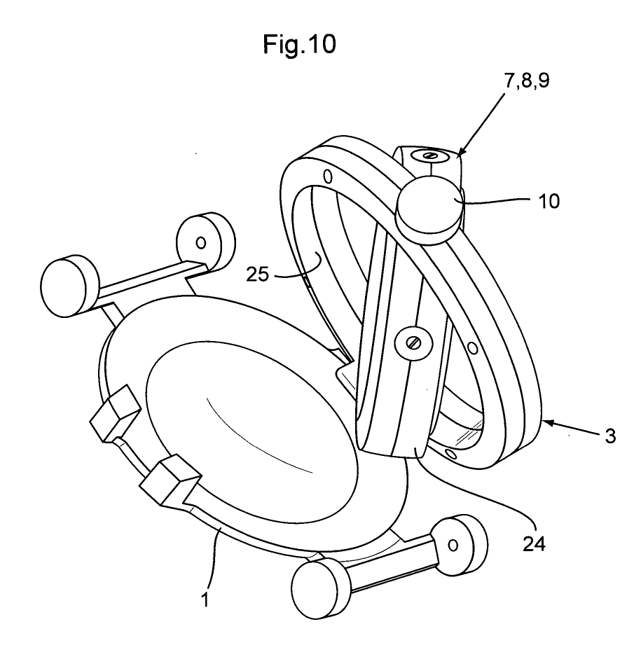

FIG. 10 is a diagrammatic perspective view showing the watch according to the first embodiment of the invention in an open position;

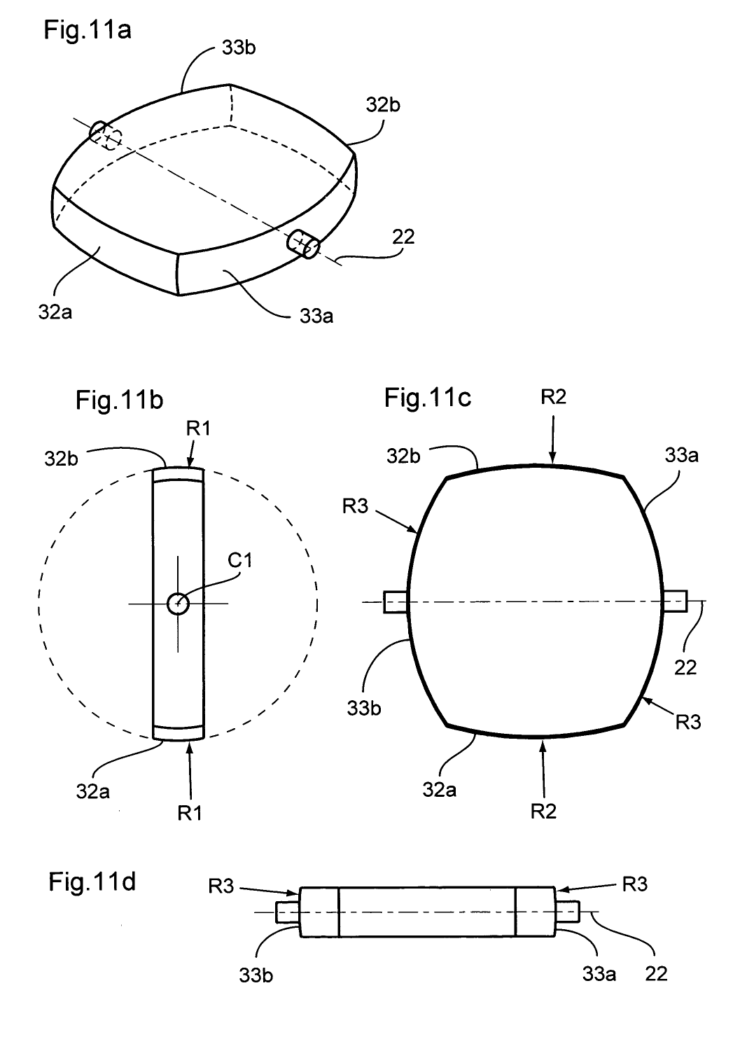

FIG. 11 diagrammatically shows the watch case of a watch according to a second embodiment of the invention in perspective view (FIG. 11a), in profile views (FIGS. 11b and 11d), and in top view (FIG. 11c); and

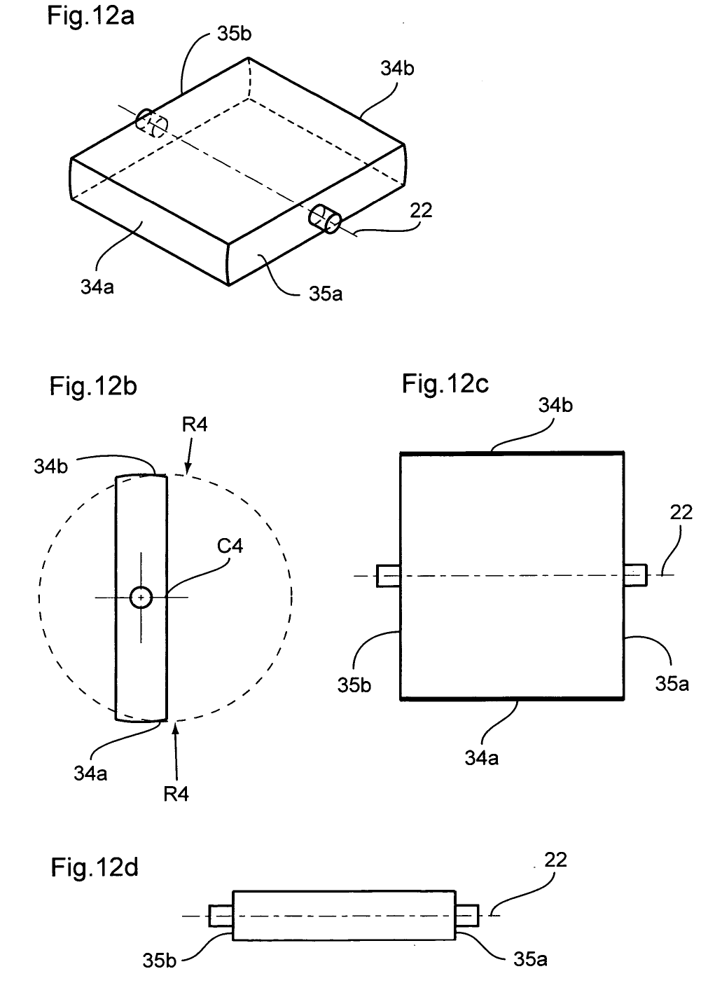

FIG. 12 diagrammatically shows the watch case of a watch according to a third embodiment of the invention in perspective view (FIG. 12a), in profile views (FIGS. 12b and 12d), and in top view (FIG. 12c).

Referring to FIGS. 1 to 10, a timepiece of the wristwatch type according to a first embodiment of the invention comprises a support 1 of generally circular shape provided at two diametrically opposite ends with elements 2a, 2b for attachment to a bracelet (not shown). A frame 3 of annular shape without back cover and having an outer diameter larger than the diameter of support 1 is articulated at one of its ends with one end of support 1 via a hinge 4, and in its rest position is overlying support 1 concentrically to this support (FIG. 2). This frame 3 consists of two pieces, a lower frame part 3a and an upper frame part 3b, assembled by means of screws 3c (FIG. 7) regularly distributed within frame 3 and each screwed into a matching blind tapped hole 3d formed in frame 3. Screws 3c, of which just one can be seen in FIG. 7, typically are four in number, but of course could be of a different number if so desired. The blind holes 3d open onto the lower face, designated 3e, of frame 3 so that the screws 3c will not be seen when the watch is on the wrist of the user and frame 3 is in its rest position.

It can be seen from FIGS. 1 to 4 that hinge 4 is comprised of a central part 4a, an outer part 4b that constitutes part of frame 3 and more particularly of the lower part 3a of this frame 3, and of screws 4c sitting inside of these central and outer parts 4a, 4b and defining the hinge's axis.

Two complementary hollows formed in parts 3a and 3b of frame 3 and located at a right angle to hinge 4 define a blind hole 3f (FIG. 6) opening into the inside of frame 3 (FIG. 6). This blind hole 3f receives a first end 5a of a pin 5. Two further complementary hollows formed in parts 3a and 3b, at the side diametrically opposite to blind hole 3f, define a through hole 3g allowing a crown's tube 6 to pass through the wall of frame 3. Pin 5 and the crown's tube 6 are secured to a watch case comprising a bezel or middle 7, a back cover 8, and a ring 9, and serve as a support for this watch case in frame 3. More particularly, a second end 5b of pin 5 is screwed and glued into ring 9, while a first end 6a of the crown's tube 6 is driven and glued into the same ring. The second end 6b of the crown's tube 6 is connected to a setting crown 10 outside frame 3. Ring 9 consists of a single piece, and is housed in a seat formed partly in bezel 7 and partly in back cover 8, that is, a seat defined by two complementary hollows formed in the inner faces of bezel 7 and back cover 8, respectively. Ring 9 itself houses a clockwork movement 11 and a dial 12, the latter being topped by a glass 13 mounted in bezel 7. Pin 5 and the crown's tube 6 pass through diametrically opposite through holes 14, 15 each formed partly in bezel 7 and partly in back cover 8 between the seat of ring 9 and the inner face of frame 3.

Advantageously, bezel 7 and back cover 8 are attached to each other by mounting bells 16, typically numbering four, that are regularly distributed along the periphery of the group of bezel 7 and back cover 8 (one of these bells 16 is represented in FIG. 8). Each mounting bell 16 is generally cylindrically shaped and on one of its faces has a central hollow 16a of truncated cone shape. Each mounting bell 16 is completely within a seat of matching shape provided partly in bezel 7 and partly in back cover 8, and is firmly held in this seat by a screw 17 extending in the plane of pin 5 and of the crown's tube 6 successively through a central through hole 18 formed in bell 16 and a through hole 19 formed partly in bezel 7 and partly in back cover 8, and up to the inside of a tapped blind hole 20 formed in ring 9. Tapped blind hole 20 receives the threaded end of screw 17. The head of screw 17 is completely within the central through hole 18 of bell 16 and rests on a shoulder 21 defined by this hole 18. Each mounting bell 16 thus constitutes an element anchored both in bezel 7 and back cover 8. In the use position of the watch, the mounting bells 16 face the inner face of frame 3, and hence are hidden by this frame, as represented in FIG. 8.

Referring again to FIG. 6, pin 5 consists of a cylindrical body 5c terminating at its end 5a in a hemispherical segment, and at its end 5b in a projection. The projection 5b and part of the cylindrical body 5c are housed in ring 9, while the hemispherical segment 5a and part of the cylindrical body 5c are freely housed in the blind hole 3f, that is, housed without being attached there. The bottom of blind hole 3f has a hemispherical shape corresponding to that of end 5a of pin 5. This hemispherical shape facilitates the realisation of blind hole 3f, in that each of the two half holes making up hole 3f can be milled with a spherical cutter set perpendicularly to the plane of the corresponding part 3a, 3b of frame 3. Pin 5 and the crown's tube 6 together define a geometric, diametric axis of rotation 22 of the watch case 7, 8, 9 relative to frame 3.

This way of mounting the watch case 7, 8, 9 into frame 3 makes the watch case 7, 8, 9 reversible. The watch case 7, 8, 9 can thus take up two rest positions or use positions parallel to frame 3. In the first position illustrated in FIG. 6, dial 12 is visible but back cover 8 is hidden. In the second position (not represented), dial 12 faces the upper face of support 1, and hence is hidden, while the outer face of back cover 8 is visible. This outer face of back cover 8 may to this effect include decoration such as enamel transforming the watch into a piece of jewelry. In a variant, though, back cover 8 could be replaced by a second bezel holding a second dial and producing an aesthetic effect that differs from that of bezel 7 associated with dial 12.

For the watch case 7, 8, 9 to be turned over within frame 3, that is, to be changed from one rest position to the other, one first rotates the group consisting of frame 3 and watch case 7, 8, 9 relative to support 1 around the axis of rotation defined by hinge 4, as shown in FIG. 1, until this group 3, 7, 8, 9 will form a sufficiently large angle with support 1. Then the watch case 7, 8, 9 is made to turn 180° around itself within frame 3, i.e. around the axis of rotation 22 that is fixed relative to frame 3, as shown in FIG. 10, so that back cover 8 will take the place of bezel 7 and vice versa. One then folds the group consisting of frame 3 and watch case 7, 8, 9 back over the support 1. It will be noted that watch case 7, 8, 9 may be turned over while the watch remains at the user's wrist, since the elements 2a, 2b for attachment to the bracelet are secured to support 1 and independent of frame 3.

Referring again to FIG. 6, two metal rings 23a, 23b are housed in respective diametrically opposite hollows made in the flank or periphery 24 of the watch case 7, 8, 9, around pin 5 and the crown's tube 6, respectively, but project very slightly from this flank 24 to the outside of watch case 7, 8, 9. These rings 23a, 23b are in frictional contact with the flank or internal face, designated 25, of frame 3 and serve to suppress the play between the respective flanks 24, 25 of the watch case 7, 8, 9 and frame 3 in the direction of axis 22, and to prevent the flanks 24, 25 from touching each other. Annular friction joints 28a, 28b are surrounded and held compressed within flank 24 against respectively the periphery of pin 5 and the periphery of the crown's tube 6 by the rings 23a, 23b. It is the function of these joints 28a, 28b to produce friction with the inner flank of frame 3 during the rotation of watch case 7, 8, 9 in order to ensure that the watch case 7, 8, 9 will not turn inopportunely within frame 3, but only under the action of a torque imparted by the user. In an alternative embodiment of the invention, these rings 23a, 23b and these joints 28a, 28b could be housed within the inner flank 25 of frame 3, and produce friction with flank 24 of the watch case 7, 8, 9.

Preferably, locking means are further provided in order to hold frame 3 unlockably in its rest position relative to support 1 (FIGS. 2, 3). These locking means advantageously take the form of two ball thrusts 26a, 26b housed in two respective projections 1a, 1b of support 1 that are located on both sides of crown 10 and function as crown protectors, the balls 26c, 26d of these thrusts engaging as ratchets into matching hollows 27 formed in the outer flank of frame 3 (FIGS. 3, 5, 9). Other locking means (not represented) may equally well be provided to unlockably maintain the watch case 7, 8, 9 in one or the other of its rest positions relative to frame 3.

The watch according to the invention is made water-tight by annular gaskets 29a, 29b held in compression between bezel 7, respectively back cover 8, and the ring 9, as well as by an annular gasket 30 held in compression between bezel 7 and glass 13. On the other hand, sealing glue is used to glue the end 5b of pin 5 and the end 6a of the crown's tube 6 into ring 9.

According to the invention, the flank 24 of watch case 7, 8, 9 and the inner flank 25 of frame 3 substantially are parts of a same surface of revolution 31 around the axis of rotation 22, in order to suppress or at least reduce the gap appearing between watch case 7, 8, 9 and frame 3. In this way, flank 24 of watch case 7, 8, 9 closely fits the inner flank 25 of frame 3 during rotary motions of watch case 7, 8, 9 around itself within frame 3.

In the example illustrated in FIGS. 1 to 10, the surface of revolution 31 is a sphere having its centre O located on axis 22, while flanks 24, 25 are parts of this sphere each limited by two parallel planes located on both sides of axis 22 and symmetric relative to this axis 22 (see FIG. 6). FIGS. 11 and 12 illustrate two further embodiments in which the flank of the watch case and the inner flank of the frame each have shape discontinuities. For the sake of clarity, only the watch case has been represented in FIGS. 11 and 12, but it will be understood that the inner flank of the frame has the same shape as the flank of the watch case. It is apparent in these FIGS. 11 and 12 that the flank of the watch case consists of two first opposite parts located on either side of the axis of rotation 22, and of two second opposite parts that intersect the axis of rotation 22 and interconnect the first parts. In the embodiment shown in FIG. 11, the first parts here designated 32a and 32b have, in a plane perpendicular to the axis of rotation 22, a first radius of curvature R1 and a centre of curvature C1 located on axis 22 (see FIG. 11b) and, in a plane containing axis 22 and running perpendicularly to the aforesaid plane, a second radius of curvature R2 larger than R1 (see FIG. 11c); the second parts, designated 33a and 33b, are spherical with a radius of curvature R3 (see FIGS. 11c and 11d), and their respective centres of curvatures are located on axis 22. In the embodiment illustrated in FIG. 12, the first parts designated 34a and 34b have, in a plane perpendicular to the axis of rotation 22, a radius of curvature R4 and a centre of curvature C4 located on axis 22 (see FIG. 12b), and are straight within a plane containing the axis 22 and running perpendicularly to the aforesaid plane (see FIG. 12c); the second parts, designated 35a and 35b, are flat and perpendicular to axis 22. The flank 34a, 35a, 34b, 35b thus consists of a cylindrical part bounded by two mutually parallel planes located on either side of axis 22 and running parallel to this axis.

In each of the embodiments illustrated in FIGS. 1 to 10, 11 and 12 the axis of rotation 22 is an axis of symmetry for the flank of the watch case and the inner flank of the frame, and these flanks have a same constant height H (see FIG. 6). In a variant, though, the axis of rotation 22 while still being located within a plane of symmetry of the flank of the watch case that is perpendicular to the plane of the watch case, could be eccentric with respect to this flank, that is, the flank of the watch case could be higher on one side of axis 22 than on the other, for instance in order to impart a particular aesthetic appearance to the watch in one of the two rest positions of the watch case within the frame. In a variant, also, the flank of the watch case and the inner flank of the frame could have different heights, for instance the flank of the watch case could be higher than the inner flank of the frame, in order to confer a particular aesthetic effect.

Furthermore, although the frame as represented in FIGS. 1 to 10 is closed, that is, surrounds the watch case along its entire periphery, the frame of the watch according to the invention could in a variant be open. In the examples illustrated in FIGS. 11 and 12, the frame could more particularly have the shape of a U.

Referring again to FIGS. 1 to 10, the watch according to the invention is assembled as follows.
1. The crown's tube 6 is driven and tightly glued into ring 9, and pin 5 is screwed and tightly glued into the same ring 9.
2. The clockwork movement 11 and the dial 12 with the corresponding hands are mounted into ring 9.
3. Glass 13 and its sleeve (annular gasket 30) are driven into bezel 7.
4. Gasket 29a is mounted into bezel 7. The group consisting of ring 9, movement 11 and dial 12 is placed into bezel 7. The gasket 29b is placed against ring 9, and back cover 8 is positioned. While holding this group 7-9, 11, 12 between two fingers, the mounting bells 16 are put into their respective seats and then screwed into ring 9.
5. The group 7-9, 11, 12 is placed into the lower frame part 3a and upper frame part 3b forming the frame 3, then frame parts 3a, 3b are fastened to each other with screws 3c. One will note in this respect that one function of the two frame parts 3a, 3b consists of enabling the group 7-9, 11, 12 to be mounted into the frame 3, despite the play between the watch case 7-9 and the frame 3 being almost absent and flank 24 of watch case 7-9 as well as the inner flank 25 of the frame 3 having the shape of parts of a surface of revolution.
6. The ball thrusts 26a, 26b are driven into the projections 1a, 1b of support 1, and screws 4c are placed into hinge parts 4a, 4b in order to articulate group 3, 7-9, 11, 12 with support 1.

1. Timepiece comprising a frame (3) in which a watch case (7, 8, 9) is mounted in reversible manner, characterised in that the watch case (7, 8, 9) is rotatable within the frame (3) around a determined axis (22) traversing the flank (24) of the watch case (7, 8, 9) and the inner flank (25) of the frame (3), and in that said flanks (24, 25) of the watch case (7, 8, 9) and of the frame (3) substantially are parts of a same surface of revolution around the determined axis (22).

2. Timepiece according to claim 1, characterised in that the determined axis (22) is an axis of symmetry for each of said flanks (24, 25).

3. Timepiece according to claim 2, characterised in that said flanks (24, 25) have substantially a same constant height (H).

4. Timepiece according to claim 1, characterised in that said flanks (24, 25) are parts of a sphere (31), the centre of which is a point (O) located on the determined axis (22).

5. Timepiece according to claim 1, characterised in that said flanks each consist of two first, opposite flank parts (32a, 32b; 34a, 34b) located on either side of the determined axis (22), and of two second, opposite flank parts (33a, 33b; 35a, 35b) intersecting the determined axis (22) and interconnecting the first flank parts (32a, 32b; 34a, 34b), each second flank part together with each first flank part defining a shape discontinuity.

6. Timepiece according to claim 1, characterised in that the frame (3) is closed.

7. Timepiece according to claim 1, characterised in that the frame (3) consists of two frame parts (3a, 3b) superimposed and assembled, the two frame parts (3a, 3b) making possible an assembly of the watch case (7, 8, 9) in the frame (3).

8. Timepiece according to claim 7, characterised in that the frame (3) comprises a blind hole (3f) with hemispherical bottom and consisting of two half holes formed in the two frame parts (3a, 3b), respectively, of the frame (3), this blind hole (3f) receiving an end (5a) of a pin (5) defining the determined axis (22).

9. Timepiece according to claim 1, characterised in that the watch case (7, 8, 9) comprises a bezel (7) and a back cover (8) or a second bezel, assembled by means of at least one element (16) anchored partly in the bezel (7) and partly in the back cover (8) or second bezel and facing the inner flank (25) of the frame (3) when the watch case (7, 8, 9) is in a rest position parallel to the frame (3), so as to be hidden by the frame (3).

10. Timepiece according to claim 9, characterised in that it comprises several anchoring elements (16) regularly distributed over the periphery of the watch case (7, 8, 9), and in that each anchoring element (16) is in the shape of a mounting bell housed in a seat of matching shape formed partly in the bezel (7) and partly in the back cover (8) or in the second bezel and in that each anchoring element (16) is fixed by means of a screw (10) to a clockwork movement support ring (9) that is housed between the bezel (7) and the back cover (8) or second bezel.

11. Timepiece according to claim 1, characterised in that the determined axis (22) coincides with the axis of a crown's tube (6) associated with the watch case (7, 8, 9), this crown's tube (6) traversing the wall of the frame (3) and having a first end (6a) housed in the watch case (7, 8, 9) and a second end (6b) associated with a setting crown (10) outside the frame (3).

12. Timepiece according to claim 1, characterised in that it further comprises at least one friction joint (28a, 28b) housed in the flank (24) of the watch case (7, 8, 9) or in the inner flank (25) of the frame (3), in order to offer friction with the inner flank (25) of the frame (3) or with the flank (24) of the watch case (7, 8, 9), respectively, upon rotation of the watch case (7, 8, 9) in the frame (3).

13. Timepiece according to claim 1, characterised in that it further comprises first and second opposite rings (23a, 23b) housed in the flank (24) of the watch case (7, 8, 9) or in the inner flank (25) of the frame (3) and surrounding the determined axis (22) so as to suppress the play between said flanks (24, 25) in the direction of the determined axis (22).

14. Timepiece according to claim 1, characterised in that the watch case (7, 8, 9) comprises a bezel (7) and a back cover (8) or a second bezel assembled to one another, as well as a clockwork movement support ring (9) housed between the bezel (7) and the back cover (8) or second bezel, in that first and second annular gaskets (29a, 29b) are kept in compression between the bezel (7) and the ring (9) and between the back cover (8) or second bezel and the ring (9), respectively, and in that a third annular gasket (30) is kept in compression between the bezel (7) and a glass (13) mounted in the bezel (7).

15. Timepiece according to claim 1, characterised in that it further comprises a support (1) provided with elements (2a, 2b) for attachment to a bracelet, and in that the frame (3) is articulated at one of its ends with one end of the support (1), so as to be able to assume a rest position where the frame (3) is superimposed upon the support (1), and an open position allowing the watch case (7, 8, 9) to be turned over in the frame (3).

16. Timepiece according to claim 15, characterised in that it further comprises means (26a-26d) for unlockably locking the frame (3) in its rest position.

17. Timepiece according to claim 16, characterised in that said means for unlockably locking the frame in its rest position comprise ratchet elements (26a-26d) housed in two crown-protecting projections (1a, 1b) of the support (1) that are located on either side of a setting crown (10) associated with the watch case (7, 8, 9).

18. Timepiece according to claim 1, characterised in that it consists of a wristwatch.

19. Timepiece according to claim 2, characterised in that said flanks (24, 25) are parts of a sphere (31), the centre of which is a point (O) located on the determined axis (22).

20. Timepiece according to claim 3, characterised in that said flanks (24, 25) are parts of a sphere (31), the centre of which is a point (O) located on the determined axis (22).
